(19) United States
(12) Patent Application Publication
(10) Pub. No.: US 2022/0156602 A1
(43) Pub. Date: May 19, 2022

(54) PREDICTION RULE CALIBRATION SYSTEM AND PREDICTION RULE CALIBRATION METHOD

(71) Applicant: Hitachi, Ltd., Tokyo (JP)

(72) Inventors: Hiroyuki NAMBA, Tokyo (JP); Masashi EGI, Tokyo (JP); Masaki HAMAMOTO, Tokyo (JP); Masakazu TAKAHASHI, Tokyo (JP)

(21) Appl. No.: 17/477,314

(22) Filed: Sep. 16, 2021

(30) Foreign Application Priority Data
Nov. 19, 2020 (JP) 2020-192808

(51) Int. Cl. G06N 5/02

(52) U.S. Cl. CPC G06N 5/025

(57) ABSTRACT

In classification problems or regression problems, a prediction rule that is highly accurate, simple, and in match with the knowledge of experts is obtained. A system includes a prediction rule simplification unit that simplifies a prediction rule of a learning model using an evaluation metric and a restriction; a branch condition search unit that updates a part of the simplified branch condition for prediction rule based on calibration information expressing a request for a prediction value or a specific branch condition; and a threshold optimization unit that updates a part of a threshold of the simplified prediction rule based on the calibration information.

### BACKGROUND OF THE INVENTION

The present invention relates to a system and a method that partially modify a prediction rule such that the prediction rule is fit into conditions requested by an expert in a system that determines whether a medical device is a non-defective item or a defective item using sensor data, for example.

In classification problems or regression problems, there is a problem that is desired to clarify the prediction rule of a learning model. For example, in a system that determines whether a medical device is a non-defective item or a defective item using sensor data, the learning model is not reliable without knowing the reasons why the learning model is a defective item. Even though the prediction rule is simple, the learning model is not reliable with no match with the knowledge of the expert. To handle this problem, in the previously existing techniques, methods are attempted in which the prediction rule of the learning model is approximated according to simple rules, or the prediction rule is modified such that the conviction degree of simple rules is improved. For example, a technique described in Japanese Unexamined Patent Application Publication No. 2000-155680 is a technique that modifies simple rules to satisfy conditions such that specific pieces of data are properly predicted.

### SUMMARY OF THE INVENTION

In the classification problem or the regression problem, the prediction rule of the learning model is sometimes unreliable due to being unclear although it is highly accurate, or due to no match with the knowledge of the expert. That is, a problem to be solved by the present invention is a problem that desires to obtain a prediction rule that is highly accurate, simple, and in match with the knowledge of experts.

An object of the present invention is to provide a prediction rule calibration system and a prediction rule calibration method that are capable of obtaining a prediction rule that is highly accurate, simple, and in match with the knowledge of experts.

A prediction rule calibration system according to an aspect of the present invention is configured as a prediction rule calibration system including a prediction rule simplification unit that simplifies a prediction rule of a learning model using an evaluation metric and a restriction; a branch condition search unit that updates a part of the simplified branch condition for prediction rule based on calibration information expressing a request for a prediction value or a specific branch condition; and a threshold optimization unit that updates a part of a threshold of the simplified prediction rule based on the calibration information.

According to the present invention, it is possible to obtain a prediction rule that is highly accurate, simple, and in match with the knowledge of experts.

### BRIEF DESCRIPTION OF THE DRAWINGS

FIG. 1 is a block diagram showing an example of the hardware configuration of a computer;

FIG. 2 is a diagram showing an example of learning data;

FIG. 3 is a diagram showing an example of a system configuration according to a first embodiment;

FIG. 4 is a diagram showing an example of a simple prediction rule;

FIG. 5 is a diagram showing an example of calibration information;

FIG. 6 is a diagram showing an example of a screen on which calibration information is inputted;

FIG. 7 is a diagram showing an example of a screen on which a calibrated simple prediction rule is confirmed;

FIG. 8 is a diagram showing the process flow of a prediction rule simplification unit according to the first embodiment;

FIG. 9 is a diagram showing the process flow of a branch condition search unit according to the first embodiment; and

FIG. 10 is a diagram showing the process flow of a threshold optimization unit according to the first embodiment.

### DETAILED DESCRIPTION OF THE PREFERRED EMBODIMENTS

### First Embodiment

In the following, embodiments of the present invention will be described with reference to the drawings. In the following, the following description and drawings are examples for explaining the present invention, and appropriately omitted and simplified for clarifying the description. The present invention is also feasible in various other forms. The number of components may be a singular number or a plural number unless otherwise specified.

For easy understanding of the invention, the positions, sizes, shapes, ranges, and other parameters of components shown in the drawings sometimes do not express the actual positions, sizes, shapes, ranges, and other parameters. For this reason, the present invention is not necessarily limited to the positions, sizes, shapes, ranges, and other parameters disclosed in the drawings.

In the following description, various items of information will be described by expressions such as “tables” and “lists”, and various items of information may be expressed by data structures other than these expressions. In order to show independence from data structures, “an XX table” and “an XX list”, for example, are sometimes referred to as “XX information”. At the time of describing identification information, in the case where expressions of “identification information”, “an identifier”, “a name”, “an ID”, and “a number”, for example, are used, these expressions are replaceable with each other.

In the case where there are a plurality of components having the same or similar functions, description may be made with different subscripts attached to the same reference signs. However, in the case where these components are not necessarily distinguished from each other, subscripts are sometimes omitted for description.

In the following description, processes executed using programs are sometimes described, the programs are executed by a processor (e.g., a Central Processing Unit (CPU) and a Graphics Processing Unit (GPU)) to appropriately perform predetermined processes using storage sources (e.g., a memory) and/or an interface device (e.g., a communication port), for example, the entity of the process may be a processor. Similarly, the entity of the process performed by executing the program may be a controller, a device, a system, a computer, and a node each having a processor. The entity of the process performed by executing the program only has to be an operating unit, and may include a dedicated circuit that performs a specific process (e.g., a Field-Programmable Gate Array (FPGA) or an Application Specific Integrated Circuit (ASIC)).

The program may be installed on a device such as a computer from a program source. The program source may be a program distribution server-readable or a computer-readable storage medium, for example. In the case where the program source is a program distribution server, the program distribution server may include a processor and a storage source that stores a program, which is a distribution target, and the processor of the program distribution server may distribute the program, which is a distribution target, to another computer. In the following description, two or more programs may be implemented as a single program, or a single program may be implemented as two or more programs.

In the following, the case is exemplified where a prediction rule calibration system and a prediction rule calibration method according to the present embodiment are applied to a system that determines whether a medical device is a non-defective item or a defective item using sensor data. However, the prediction rule calibration system and the prediction rule calibration method are widely applicable to the case of determining whether various devices or their components other than medical devices are a non-defective item or a defective item.

As a first embodiment of the present invention, a method of calculating a prediction rule based on learning data, a learning model, and calibration information will be described. In the present embodiment, first, a learning model is converted into a simple prediction rule similarly to previously existing techniques. The knowledge of experts is inputted as calibration information that describes a request for a prediction value or a request for a specific prediction rule, and the prediction rule is partially modified such that the calibration information is satisfied. Specifically, to the request for the prediction value, the threshold of branch conditions for the prediction rule is modified. To the request for the specific prediction rule, a part of the prediction rule including the branch condition that is a request target is changed, and the calibration of the prediction rule is repeated. In the following, the first embodiment will be described more in detail with reference to the drawings.

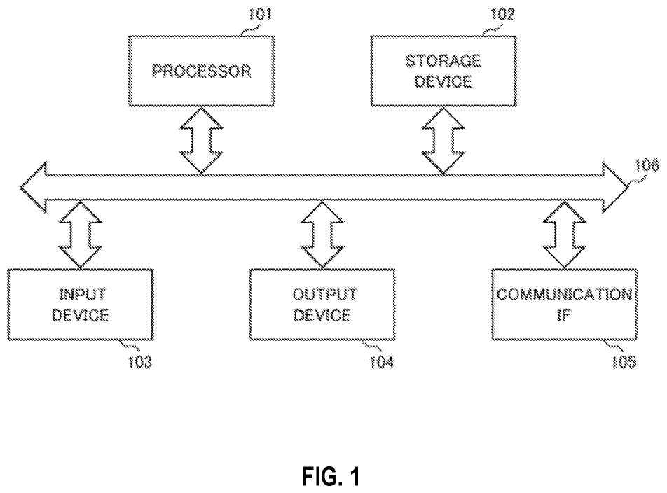

FIG. 1 is a block diagram showing an example of the hardware configuration of a computer 100. The computer 100 has a processor 101, a storage device 102, an input device 103, an output device 104, and a communication interface (communication IF) 105. The processor 101, the storage device 102, the input device 103, the output device 104, and the communication IF 105 are connected to each other through a bus 106. The processor 101 controls the computer 100. The storage device 102 is the work area of the processor 101. The storage device 102 is a non-transitory or transitory recording medium that stores various programs or data. Examples of the storage device 102 include a Read Only Memory (ROM), a Random Access Memory (RAM), a Hard Disk Drive (HDD), and a flash memory. The input device 103 inputs data. Examples of the input device 103 include a keyboard, a mouse, a touch panel, a ten key pad, and a scanner. The output device 104 outputs data. Examples of the output device 104 include a display, a printer, and a speaker. The communication IF 105 connects to a network, and transmits and receives data. An example of the communication IF 105 includes a Network Interface Card (NIC).

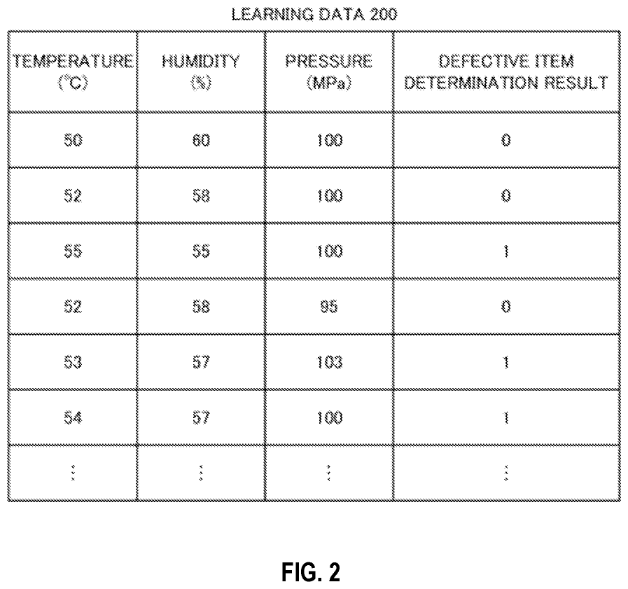

FIG. 2 is an illustration showing an example of learning data according to the first embodiment. Learning data 200 includes information of one or more explanatory variables and one response variable. The learning data 200 has the temperature, humidity, and pressure in manufacture expressing explanatory variables and a defective item determination result expressing a response variable, as columns, for example. The temperature, humidity, and pressure express process parameters at the time of manufacture, and the defective item determination result is a binary variable expressing that zero expresses a non-defective item and 1 expresses a defective item. The entry at the first row expresses that a product obtained in processing at a temperature of 50° C., a humidity of 60%, and a pressure of 100 MPa was a non-defective item. In the present embodiment, although the response variable is a binary value, the response variable may be a continuous value like the size of a product, for example.

A learning model 210 is a program that upon inputting the combination of the values of the explanatory variable of the learning data 200, the prediction value of the response variable is outputted. For example, the learning model 210 is a program that upon inputting the combination of the values of the explanatory variables, a temperature of 55° C., a humidity of 60%, and a pressure of 100 Mpa, an output of 1 is obtained as the prediction value of the response variable, i.e., an output is obtained that the product is predicted as a defective item. In the present embodiment, although the prediction value of the response variable, which is an output, the binary value, 0 or 1, the prediction value of the response variable may be a continuous value.

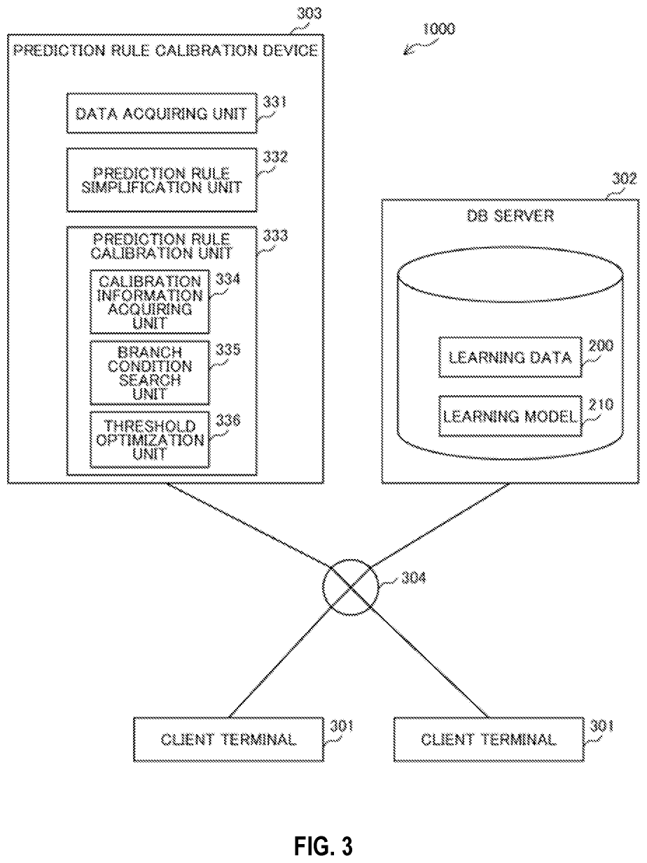

FIG. 3 is a block diagram showing an example of the system configuration of a prediction rule calibration system 300 according to the first embodiment. The prediction rule calibration system 300 has one or more client terminals 301, a database (DB) server 302, and a prediction rule calibration device 303. The client terminal 301, the DB server 302, and the prediction rule calibration device 303 are connected to each other via a network 304 such as the Internet, a Local Area Network (LAN), and a Wide Area Network (WAN) in a manner that enables communication. The client terminal 301, the DB server 302, and the prediction rule calibration device 303 are implemented by the computer 100 shown in FIG. 1.

The DB server 302 stores the learning data 200 and the learning model 210. The learning data 200 and the learning model 210 may be stored in the prediction rule calibration device 303.

The prediction rule calibration device 303 has a data acquiring unit 331, a prediction rule simplification unit 332, and a prediction rule calibration unit 333. Specifically, for example, the data acquiring unit 331, the prediction rule simplification unit 332, and the prediction rule calibration unit 333 are functions implemented by executing programs stored in the storage device 102 shown in FIG. 1.

The data acquiring unit 331 accesses the DB server 302, acquires the learning data 200 and the learning model 210 from the DB server 302, and stores the learning data 200 and the learning model 210 in the storage device 102.

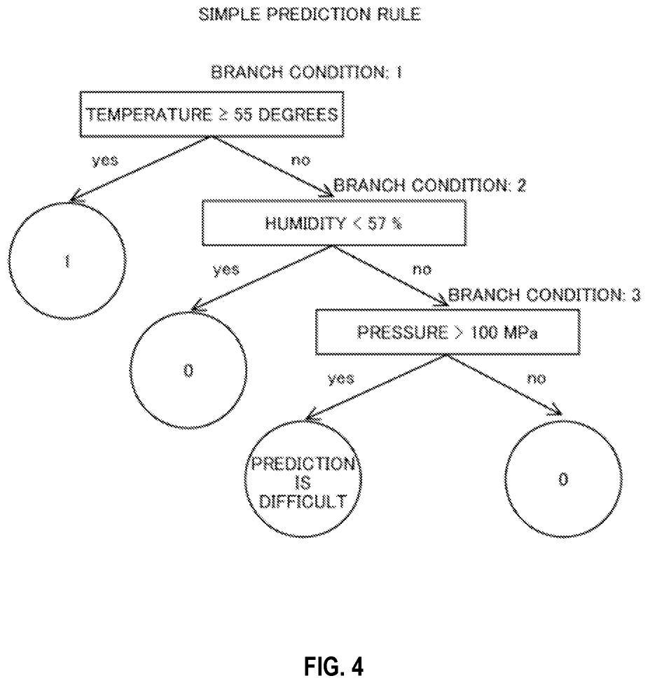

The prediction rule simplification unit 332 is a program that creates a simple prediction rule based on the learning data 200 and the learning model 210. Here, the simple prediction rule expresses a prediction rule that simplifies some or all of the learning data 200 by a tree structure. FIG. 4 shows an example of a simple prediction rule. The node of the simple prediction rule expresses branch condition, and upon inputting the combination of explanatory variables, a branch destination is determined. The right-hand side of the branch condition is set to a real number. To the leaf of the simple prediction rule, a flag indicating that prediction is difficult in the prediction value or the simple prediction rule corresponds. For example, in the simple prediction rule in FIG. 4, data, a temperature of 50° C., a humidity of 60%, and a pressure of 100 MPa, in the learning data in the first row reaches the rightmost leaf to predict that the defective item determination result is 0, i.e., the product is the non-defective item. Data, a temperature of 53° C., a humidity of 57%, and a pressure of 103 MPa shown in the learning data in the fifth row, reaches the second-right leaf to predict that prediction is difficult, prediction being difficult. It should be noted that the number of variables forming one node of the simple prediction rule may be one like in FIG. 4, or may be a plural number. For example, there may be a node that the temperature divided by the pressure is 0.5 or more. The prediction value of the leaf may be a binary value like in FIG. 4, or may be a continuous value. To the nodes of the simple prediction rule, a branch condition ID is assigned. The simple prediction rule that does not allow prediction being difficult as the value of the leaf matches a typical decision tree. Specifically, in the case where a prediction value is a binary value, the simple prediction rule matches a classification tree to a binary classification problem, whereas in the case where a prediction value is a continuous value, the simple prediction rule matches a regression tree.

When the prediction rule simplification unit 332 creates a simple prediction rule, a restriction relating to the evaluation metric and the tree structure and a restriction relating to data indicating that prediction is difficult is preset. The settings may be inputted beforehand from the client terminal 301, or may be hard-coded in the prediction rule simplification unit 332. Here, the evaluation metric may be the accuracy of binary classification, or may be a square error in a regression problem. Here, when the evaluation metric is calculated to the entire learning data 200 of the simple prediction rule, the prediction value is necessary to each row of learning data. However, the calculation of the prediction value fall to data indicating that prediction is difficult. As described above, to the data indicating that prediction is difficult, the original learning model 210 is applied to calculate the prediction value. That is, it is considered that a set of the simple prediction rule and the learning model 210 is one prediction model, and thus the evaluation metric to the entire learning data 200 of the simple prediction rule can be calculated. The restriction relating to the tree structure is the number of variables forming the depth of the tree and the node, for example. For example, there is a restriction that the depth of the tree is three or less and the number of variables forming the node is one. The restriction relating to data indicating that prediction is difficult is a restriction that the simple prediction rule brings data indicating that prediction is difficult. Examples of restrictions include a restriction that the ratio of data of the prediction rule is set to 20% or less or a restriction that a specific piece of data is not set to prediction being difficult.

The prediction rule simplification unit 332 searches for a simple prediction rule that the evaluation metric is optimum while the restriction relating to the tree structure and the restriction relating to data indicating that prediction is difficult are satisfied. The detail of the process flow of the prediction rule simplification unit 332 will be described later.

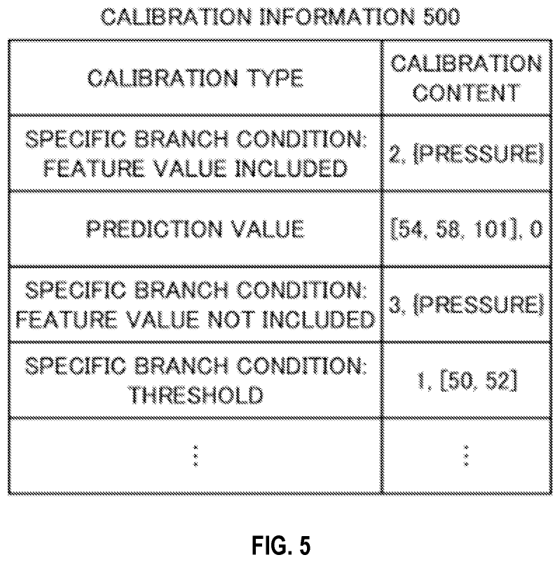

The prediction rule calibration unit 333 is a program that calculates the calibrated simple prediction rule based on the simple prediction rule and calibration information 500. Here, the calibration information 500 is information indicating a request for modification of the output value of the simple prediction rule or a specific branch condition. An example of the calibration information is shown in FIG. 5. The calibration information is formed of one or more calibration condition elements. The calibration condition element indicates one row in FIG. 5. The calibration condition element has an attribute that is a calibration type and a calibration content. The calibration type is any one of four types below.

The first one is a type that is a request for a specific branch condition and that specifies a feature value, which has to be included. For example, the first row in FIG. 5 corresponds to this type. The calibration content of the calibration condition element having this type has the branch condition ID of the simple prediction rule and the list of feature values, which have to be included. For example, the first row in FIG. 5 specifies 2, {pressure}, which express a request for the branch condition having ID2 to desirably include an explanatory variable, which is pressure.

The second one is a type that is a request for a specific branch condition and that specifies a feature value, which does not have to be included. For example, the third row in FIG. 5 corresponds to this type. The calibration content of the calibration condition element having this type has the branch condition ID of the simple prediction rule and the list of feature values, which do not have to be included. For example, the third row in FIG. 5 specifies 3, {pressure}, which expresses a request for the branch condition having ID3 desirably not to include an explanatory variable, which is pressure.

The third one is a type that is a request for a specific branch condition and that specifies the range of a threshold. Here, the threshold expresses the right-hand side of the branch condition. For example, the fourth row in FIG. 5 corresponds to this type. The calibration content of the calibration condition element having this type has the branch condition ID of the simple prediction rule and a range in which the threshold has to be included. For example, the fourth row in FIG. 5 specifies 1, [50, 52], which expresses a request for the branch condition having ID1 that the threshold is desirably 50 or more and 52 or less. As intervals, an open interval can be specified. For example, in the case where [50, 53] is specified, this expresses a request that the threshold is desirably 50 or more and less than 53.

The fourth one is a type that is a request regarding the prediction value. For example, the second row in FIG. 5 corresponds to this type. The calibration content of the calibration condition element having this type has the list of pairs expressing a size relationship. The elements of the pairs the list of all values of the explanatory variables or real numbers. In the case of the list of all values of the explanatory variables, this expresses the prediction value of the simple prediction rule in this case of the values of the explanatory variables. The calibration condition element of this type expresses a request that the first element of the pair is desirably the second element or less. For example, the second row in FIG. 5 specifies [54, 58, 101], 0, which expresses a request that the prediction value of the simple prediction rule in the case where the temperature is 54° C., the humidity is 58%, and the pressure is 101 Mpa is desirably zero or less. In the present embodiment, the prediction value is 0 or 1, and this request is equivalent to a request that the prediction value is desirably zero. The calibration condition element of this type acne be used for specifying the prediction value of a specific piece of data or for specifying that the value of the response variable of a specific piece of data is desirably properly predicted.

The prediction rule calibration unit 333 has a calibration information acquiring unit 334, a branch condition search unit 335, and a threshold optimization unit 336.

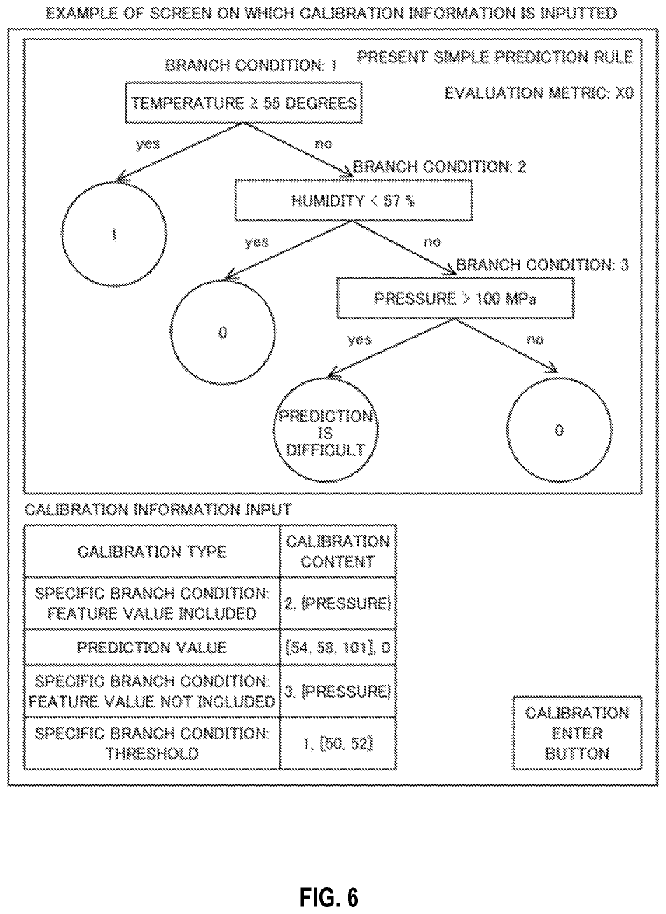

The calibration information acquiring unit 334 is a program that sends a simple prediction rule, which is the output of the prediction rule simplification unit 332 to the client terminal 301, displays a screen as shown in an example of FIG. 6 to prompt the input of calibration information, acquires the calibration information 500 inputted through the client terminal 301, and outputs the calibration information 500 to the branch condition search unit 335. Here, the screen on which the calibration information shown in FIG. 6 has a section on which the present simple prediction rule is displayed, a section in which the calibration information is inputted, and a calibration execution button. On the section on which the present simple prediction rule is displayed, the tree structure of the simple prediction rule, which is the output of the prediction rule simplification unit 332 is displayed. Together with this, the value of one or more evaluation metrics is displayed. Examples of the evaluation metric include the accuracy of binary classification, a square error in a regression problem, the ratio of data indicating that prediction is difficult, or the like.

To the section in which the calibration information is inputted, the calibration information 500 can be inputted through the client terminal 301. For example, the input to the calibration type column is selected from the prediction value or the branch condition from a pulldown menu, an input can be freely made to the calibration content column, and a button increasing and a button decreasing the number of columns of the calibration informational are provided. For the columns that the calibration type column is the prediction value, a specific column of the learning data 200 may be specified when the list of all values of the explanatory variables is specified to the calibration content column. That is, a method may be provided in which when the calibration information is inputted, the table of the learning data 200 is displayed on the screen, a user specifies one column of the table, and then all values of the explanatory variables in that column are reflected on the calibration content column.

Upon pressing the calibration execution button, an input signal is transmitted to the calibration information acquiring unit 334 of the prediction rule calibration device 303.

The branch condition search unit 335 is a program that updates the branch condition such that calibration information is satisfied to the simple prediction rule inputted from the calibration information acquiring unit 334. It should be noted that when the branch condition search unit 335 searches for the branch condition, the threshold optimization unit 336 is also utilized.

The threshold optimization unit 336 is a program that updates the threshold such that calibration information is satisfied to the simple prediction rule inputted from the calibration information acquiring unit 334. The detail of a process flow of calculating the calibrated simple prediction rule by the branch condition search unit 335 and the threshold optimization unit 336 will be described later.

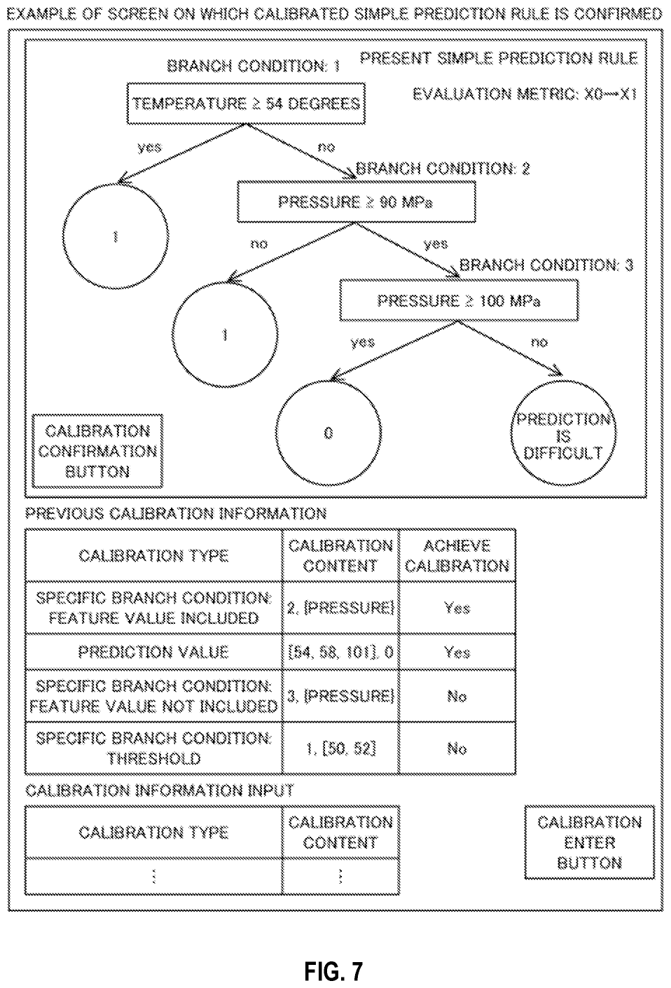

The calibrated simple prediction rule is transmitted to the client terminal 301, and displayed on a screen as shown in FIG. 7. Here, as shown in an example of FIG. 7, the screen on which the calibrated simple prediction rule is confirmed has a section on which the present simple prediction rule is displayed, a section on which previous calibration information is displayed, a calibration enter button that determines whether calibration is accepted and entered, a section in which the calibration information is inputted, and a calibration execution button. On the section on which the present simple prediction rule is displayed, the calibrated simple prediction rule transmitted from the threshold optimization unit 336 is displayed. In doing so, the transition of the evaluation metrics from the previous simple prediction rule to the calibrated simple prediction rule this time are also displayed. On the section on which the previous calibration information is displayed, calibration information previously inputted on the screen on which the calibration information is inputted is displayed. In doing so, a calibration achievement column expressing whether the calibrations of the pieces of calibration information are achieved is added and displayed. The section in which the calibration information is inputted and the calibration execution button are similar to the screen on which the calibration information shown in FIG. 6 is inputted.

The calibration enter button is a button that accepts the previous calibration to determine whether to update the simple prediction rule. In the case where the evaluation metric and the calibrated simple prediction rule are confirmed and the previous calibration is accepted, the calibration enter button is pressed down to update the simple prediction rule, and thus calibration can be repeated based on a new simple prediction rule. On the other hand, in the case where the previous calibration is not accepted, then the calibration enter button is not pressed down, the calibration information is again inputted, the calibration execution button is pressed down, and thus calibration can be restarted from the state of the previous simple prediction rule. In any case, upon pressing down the calibration execution button, information on the simple prediction rule that is the source is again transmitted to the prediction rule calibration device 303, and the process of the prediction rule calibration unit 333 is executed. The executed result is again displayed on the client terminal 301 as the screen on which the calibrated simple prediction rule is confirmed, as shown in FIG. 7. As described above, in order to obtain a prediction rule in match with the knowledge of experts while accuracy is maintained, the input operation of calibration information, the execution process of calibration, and the operation of entering calibration can be repeated.

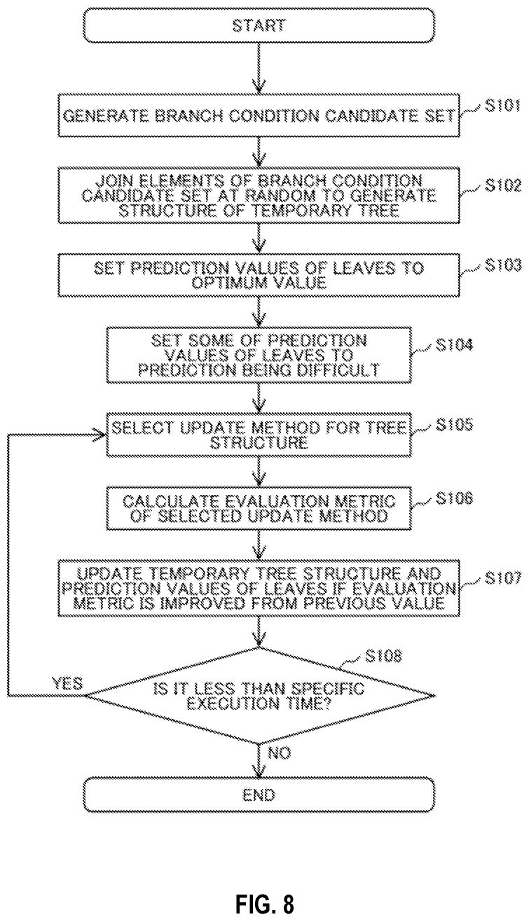

Next, the process flows of the prediction rule simplification unit 332, the branch condition search unit 335, and the threshold optimization unit 336 will be described. The process flow of the prediction rule simplification unit 332 is shown in FIG. 8. In the following, the detail of the steps in FIG. 8 will be described.

Step S101 is the process of enumerating candidates for the branch condition. For example, the prediction rule simplification unit 332 enumerates candidates for the branch condition X≥α for all explanatory variables X and all thresholds α of the learning data 200. Here, all thresholds α are all values of the explanatory variables X in the learning data 200. For example, in the case where the explanatory variable, pressure, in the learning data 200 has three valuables, 95, 100, and 103, the prediction rule simplification unit 332 enumerates, as the branch condition regarding the pressure, three candidates, pressure≥95, pressure≥100, and pressure≥103. The entire enumerated candidates are referred to as a branch condition candidate set.

Step S102 is the process of determining the initial state of a search. Specifically, the prediction rule simplification unit 332 joins elements of the branch condition candidate set at random to generate a temporary tree structure. In doing so, the restriction relating to the tree structure is satisfied. Examples of specific methods of joining elements at random include a method in which one element is extracted at random to form a tree at depth 1, a method in which N elements are extracted at random to form a path at depth N, or the like. A tree at the present point in time in search is referred to as a temporary tree.

In Step S103, the prediction rule simplification unit 332 sets the prediction values of the leaves of the temporary tree to optimum values. This is similar to a method of generating a typical decision tree. For example, in the case where the evaluation metric is a square error, the prediction rule simplification unit 332 sets the mean value of the response variables of data reaching the leaves to the prediction value. In the case where the evaluation metric is the accuracy rate of multilevel classification, the prediction rule simplification unit 332 sets the mode of the response variables of data reaching the leaves to the prediction value.

In Step S104, the prediction rule simplification unit 332 sets some of the prediction values of the leaves of the temporary tree to prediction being difficult. This is for improving the evaluation metric by changing the prediction values of the leaves of the temporary tree to prediction being difficult, i.e., by changing to a learning model 210 that is not simplified to form a black box. That is, the prediction rule simplification unit 332 sacrifices the ratio of data that can be predicted by the simple prediction rule, and improves the evaluation metric. As an example of a specific process, the prediction rule simplification unit 332 maximizes the evaluation metric while satisfying the restriction relating to data indicating that prediction is difficult. For example, there is a method in which the prediction values are in turn changed from the leaf having the most increased evaluation metric by changing to prediction being difficult immediately before the restriction is imposed.

From Step S105 to Step S107, the prediction rule simplification unit 332 optimizes the evaluation metric while partially updating the temporary tree.

In Step S105, the prediction rule simplification unit 332 selects an update method for the temporary tree. For example, the prediction rule simplification unit 332 selects a method at random from the addition of a branch, the removal of a branch, and the replacement of a branch. Here, the addition of a branch is a process in which the leaf of the temporary tree is selected at random and an element of the branch condition candidate set selected at random is added to the leaf. The removal of a branch is a process in which the lowest branch condition is removed at random, and is replaced by a leaf. The replacement of a branch is a process in which the branch of the temporary tree is selected at random and an element, which is selected at random, of the branch condition candidate set is added at that site.

In Step S106, the evaluation metric of the update method selected by the prediction rule simplification unit 332 is calculated. Since the update method for the structure of the temporary tree is determined in Step S105, the prediction rule simplification unit 332 calculates the optimum value of the leaf similarly in Step S103, changes some of the leaves to prediction being difficult similarly in Step S104, and calculates the evaluation metric of the temporary tree.

In Step S107, the prediction rule simplification unit 332 compares the evaluation metric this time calculated in Step S106 with the evaluation metric of the temporary tree before updating, and determines whether the temporary tree is updated. For example, when the evaluation metric this time is higher than the evaluation metric before updating, the prediction rule simplification unit 332 updates the temporary tree, and if not, the temporary tree is unchanged.

In Step S108, the prediction rule simplification unit 332 determines whether it is less than the specific execution time. In the case where the determination of the prediction rule simplification unit 332 determines that it is less than the specific execution time, (S108: YES), the determination of the prediction rule simplification unit 332 repeats Step S105 to S107, and continues the improvement of the temporary tree. On the other hand, in the case where the prediction rule simplification unit 332 determines that it is the specific execution time or more (S108: NO), the prediction rule simplification unit 332 outputs the temporary tree at this point in time as a simple prediction rule. Here, the specific execution time of the prediction rule simplification unit 332 may be hard-coded, or may be time inputted by an analyst in advance through the client terminal 301.

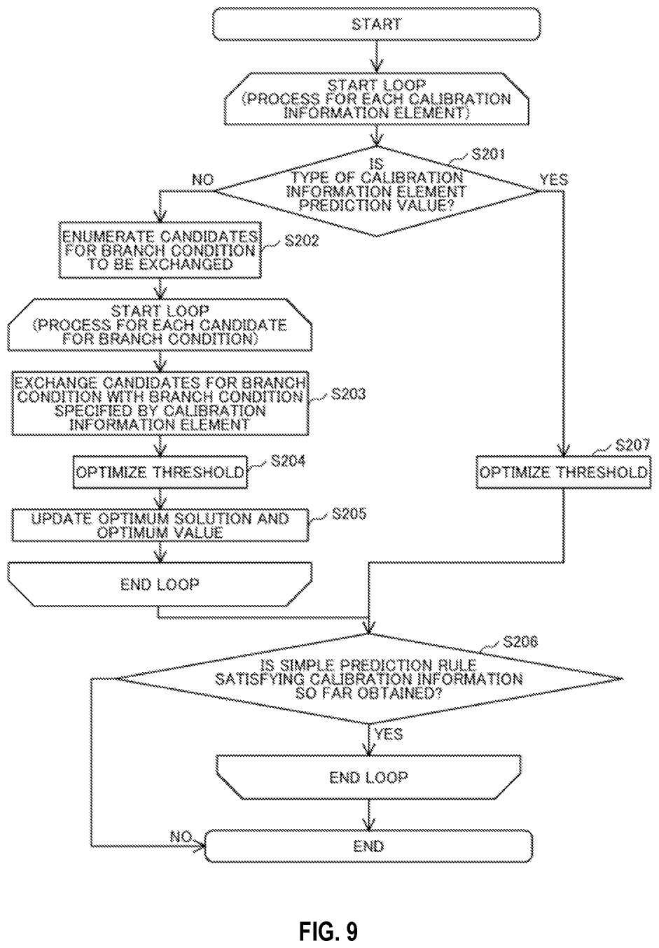

Next, the process flow of the branch condition search unit 335 is shown in FIG. 9. In the following, the detail of the steps in FIG. 9 will be described. Step S201 to Step 206 are performed on the inputted columns of the calibration information 500.

In Step S201, the branch condition search unit 335 determines whether the calibration condition element that is a processing target, i.e., the type of one column of the calibration information 500 is a prediction value. In the case where the branch condition search unit 335 determines that the element is not a prediction value (S201: NO), i.e., the case of a request for a specific branch condition, the process goes to Step S202. On the other hand, in the case where the branch condition search unit 335 determines that the element is a prediction value (S201: YES), the process goes to Step S207.

At the time of executing Step S202, the type of the calibration condition element that is a processing target relates to a specific branch condition. In this case, from S202 to S205, the branch condition search unit 335 updates the simple prediction rule such that the evaluation metric is the maximum while the request for the specific branch condition is satisfied. Specifically, in S203, the branch condition search unit 335 exchanges some branch conditions {M_1, M_2, . . . } to the other branch conditions {N_1, N_2, . . . } based on the calibration condition element that is a processing target. In S204, the branch condition search unit 335 optimizes thresholds for various exchanges, and finally outputs the branch condition having the best evaluation metric. The detail of the steps is as follows.

In Step S202, candidates for the exchange are enumerated. For example, the branch condition search unit 335 exchanges only the branch condition {M_1} having its ID specified by the calibration content of the calibration condition element that is a processing target, and enumerates the candidate {N_1} that is the exchange destination. For example, as described in the first row of the calibration information 500, in the case where the variable pressure is desired to be included in the branch condition, the branch condition search unit 335 enumerates branch conditions, pressure 100 Mpa, pressure 105 Mpa, and so on. Specifically, this can be implemented in which in the branch condition candidate set created by the prediction rule simplification unit 332, candidates including the variable pressure in the branch condition are all enumerated. Step S203 to S205 are performed on all the candidates enumerated in Step S202.

In Step S203, the branch condition search unit 335 exchanges the candidate for the processing target with the branch condition specified by the calibration information element. For example, in the case where the first row of the calibration information 500 shown in FIG. 5 is processed, the node having branch condition ID2 is exchanged by a new candidate such as pressure 100 Mpa.

In Step S204, using the temporary tree that is the output in S203 as an input, the branch condition search unit 335 invokes the threshold optimization unit 336 to optimize the threshold. The detail of the process of the threshold optimization unit 336 will be described later.

In Step S205, the branch condition search unit 335 updates the optimum solution and the optimum value in search in S203 to S205. Specifically, when optimum value E_0 that is the evaluation metric of the present simple prediction rule is not better than evaluation metric E of the simple prediction rule outputted this time in S204, the branch condition search unit 335 updates the optimum value to E, and updates the optimum solution to the simple prediction rule outputted this time in S204. If not, the branch condition search unit 335 makes no update.

Upon finishing all loops for candidate A, the branch condition search unit 335 outputs a simple prediction rule that is the optimum solution, and the process goes to Step S206.

In Step S206, the branch condition search unit 335 determines whether simple prediction rule T obtained until S205 satisfies all the calibration information elements processed so far. For example, in the case where the calibration condition element that is the processing target is the second row of the calibration information 500, the branch condition search unit 335 determines whether the simple prediction rule T satisfies the conditions in the first row and the second row of the calibration information 500. In the case where the branch condition search unit 335 determines that these conditions are satisfied (S206: YES), T is set to the latest simple prediction rule, and the branch condition search unit 335 goes to the process of the next calibration information element. On the other hand, in the case where the branch condition search unit 335 determines that these conditions are not satisfied (S206: NO), the process is ended. At this time, the branch condition search unit 335 outputs the present simple prediction rule T, which is necessary to display the screen shown in FIG. 7, and whether T satisfies the calibration information element.

Similarly to S204, in Step S207, the branch condition search unit 335 invokes the threshold optimization unit 336 to optimize the threshold of the latest simple prediction rule.

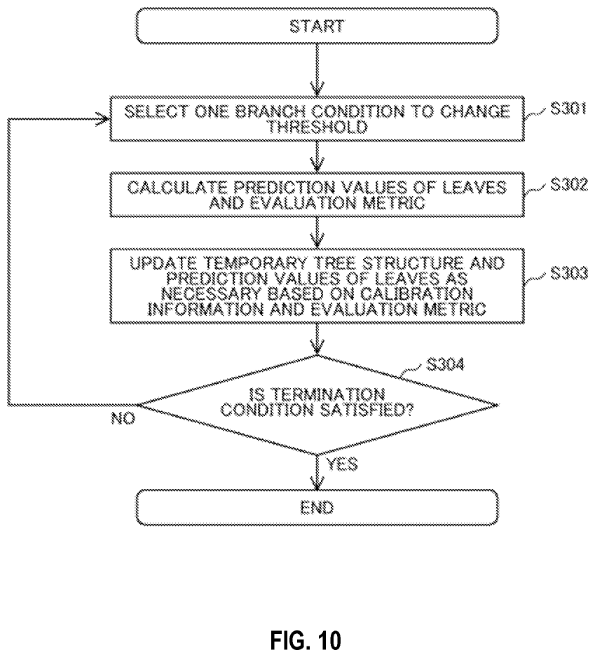

Next, the process flow of the threshold optimization unit 336 is shown in FIG. 10. The threshold optimization unit 336 repeats changing the threshold of the branch condition of the simple prediction rule, and calculates the simple prediction rule with a high evaluation metric while the calibration information is satisfied. In the following, the detail of the steps in FIG. 10 will be described.

In Step S301, the threshold optimization unit 336 selects the branch condition for the temporary tree, and changes the threshold. For example, one branch condition is selected at random, and the threshold is changed to a random value. The amount of a change in the threshold is not necessarily a random amount, may be a predetermined certain amount, or may be the minimum amount while the conditions is satisfied in which the evaluation metric fluctuates by changing the threshold.

In Step S302, the threshold optimization unit 336 first recalculates the prediction values of the leaves of the temporary tree determined in Step S301 similarly to Step S103. Similarly to Step S104, the threshold optimization unit 336 sets some of the leaves to prediction being difficult. The threshold optimization unit 336 calculates the evaluation metric of the temporary tree.

In Step S303, the threshold optimization unit 336 determines whether the temporary tree is updated to a tree calculated up to Step S302 or not, and the threshold optimization unit 336 updates the temporary tree as necessary. In the determination, the calibration information 500 and the evaluation metric are used. For example, the threshold optimization unit 336 determines update when the calibration information is satisfied and the evaluation metric is improved by update. Here, to satisfy the calibration information may express that only the calibration condition element being processed presently, or may express that all the calibration condition elements processed so far to the present are satisfied.

In Step S304, the threshold optimization unit 336 determines whether the termination condition is satisfied. In the case where the threshold optimization unit 336 determines that the termination condition is not satisfied (S304: NO), the process again returns to Step S301, whereas in the case where the threshold optimization unit 336 determines that the termination condition is satisfied (S304: YES), the threshold optimization process is ended. The termination condition may be the condition in which the number of times executed in Step S304, for example, is a certain value or more, or may be the condition in which the execution time of the threshold optimization unit 336 is certain time or longer.

As described above, according to the present embodiment, the prediction rule calibration system 300 has the prediction rule simplification unit 332 that simplifies the prediction rule of the learning model 210 using the evaluation metric and the restriction (e.g. the restriction relating to the tree structure and the restriction relating to data indicating that prediction is difficult), which are preset, the branch condition search unit 225 that updates a part of the branch condition for the prediction rule based on the calibration information 500 expressing request for the prediction value or a specific branch condition, and the threshold optimization unit 336 that updates a part of the threshold of the simplified prediction rule based on the calibration information, in which a minute modification of the prediction rule is repeated such that the calibration information that describes the request for the prediction value or the request for the specific prediction rule is satisfied, and thus it is possible to output a prediction rule that is highly accurate, simple, and in match with the knowledge of experts.

### Second Embodiment

As a second embodiment of the present invention, a method of calculating a prediction rule based on learning data and calibration information will be described. Although the present embodiment is similar to the first embodiment, some points of the present embodiment are different.

First, the present embodiment does not use the learning model 210 prepared beforehand as an input. In this case, a learning model is created by a typical method using learning data before a prediction rule simplification unit 332 is executed. Here, examples of typical methods include a neural network, a gradient boosting tree, and a random forest. Any of these methods can generate a learning model from learning data both in the case of the classification problem and in the case of the regression problem.

In Step S301 of the threshold optimization unit 336, in the first embodiment, the branch condition for the temporary tree is selected at random to change the threshold. However, in the present embodiment, the change target for the threshold is limited only to the lower subtree of the branch condition specified by the calibration condition element. For example, in the simple prediction rule in FIG. 4, in the case where the calibration condition element to the branch condition ID2 is processed, the change target for the threshold is limited to the threshold of the branch condition ID2 or the branch condition ID3, and the threshold of the branch condition ID1 is not changed.

As described above, in the present embodiment, the sections updated by a simplified prediction rule at a branch condition search unit 335 and a threshold optimization unit 336 are limited to the lower subtree of the branch condition specified by calibration information 500. Therefore, even in the case where the temporary tree is larger than a certain size, it is possible to partially change the threshold, and it is possible to process the calibration condition element more efficiently.

In the first embodiment, in Step S202 of the branch condition search unit 335, all the exchange candidates that satisfy the conditions are enumerated when the exchange candidates for the branch condition are enumerated. On the other hand, in the present embodiment, the branch condition candidates that satisfy the conditions are further limited using correlation analysis, and the efficiency of search is improved. For example, in the case where the calibration condition element is processed in which a specific branch condition includes the variable humidity and the humidity is not desirably included, all branch condition candidates including no humidity are not searched, and only branch condition candidates including a variable having a correlation with humidity at a certain level or higher are searched. For example, the correlation coefficient between humidity and all the other explanatory variables is calculated, K explanatory variables having a high correlation coefficient are extracted, and only branch condition candidates including any of K explanatory variables are searched. In the case where the other explanatory variable having the highest correlation with humidity is the temperature under K=1, only the branch conditions including the temperature are enumerated as the exchange target for the branch condition including humidity.

As described above, in the present embodiment, the section updated by the branch condition search unit 335 is limited to the branch condition specified by the calibration information 500. The branch condition search unit 335 performs the process of extracting the variable forming the branch condition before updating and the variable having a high correlation. Thus, it is possible to execute more efficient searches. In this case, the section in which the prediction rule simplified by the branch condition search unit 335 and the threshold optimization unit 336 is updated is limited to the lower subtree of the branch condition specified by the calibration information 500, and thus it is possible to more efficiently process the calibration condition element as described above.

In the present embodiment, in the presentation of the present simple prediction rule in FIGS. 6 and 7, additional information corresponding to the branch condition is presented every time the branch condition ID is clicked. For example, a schematic diagram of a real system and sites corresponding to variables forming the branch condition in the schematic diagram are presented. In a system that determines whether a medical device is a non-defective item or a defective item using sensor data, for example, the schematic diagram of the manufacture lines and the sites of sensors are displayed. In the case where the variable forming the branch condition ID is the temperature, the site of the sensor acquiring the temperature is presented in highlight.

What is claimed is:

1. A prediction rule calibration system comprising:
a prediction rule simplification unit that simplifies a prediction rule of a learning model using an evaluation metric and a restriction;
a branch condition search unit that updates a part of the simplified branch condition for prediction rule based on calibration information expressing a request for a prediction value or a specific branch condition; and
a threshold optimization unit that updates a part of a threshold of the simplified prediction rule based on the calibration information.

2. The prediction rule calibration system according to claim 1, wherein in the branch condition search unit and the threshold optimization unit, a section in which the simplified prediction rule is updated is limited to a lower subtree of a branch condition specified by the calibration information.

3. The prediction rule calibration system according to claim 1,
wherein a section that is updated in the branch condition search unit is limited to a branch condition specified by the calibration information; and
in the branch condition search unit, a process of extracting a variable having a high correlation with a variable forming a branch condition before updating is performed.

4. The prediction rule calibration system according to claim 3, wherein in the branch condition search unit and the threshold optimization unit, a section in which the simplified prediction rule is updated is limited to a lower subtree of a branch condition specified by the calibration information.

5. A prediction rule calibration method performed in a computer,
wherein a prediction rule simplification unit simplifies a prediction rule of a learning model using an evaluation metric and a restriction;
a branch condition search unit updates a part of the simplified branch condition for prediction rule based on calibration information expressing a request for a prediction value or a specific branch condition; and
a threshold optimization unit updates a part of a threshold of the simplified prediction rule based on the calibration information.

6. The prediction rule calibration method according to claim 5, wherein in the branch condition search unit and the threshold optimization unit, a section in which the simplified prediction rule is updated is limited to a lower subtree of a branch condition specified by the calibration information.

7. The prediction rule calibration method according to claim 5,
wherein a section that is updated in the branch condition search unit is limited to a branch condition specified by the calibration information; and
in the branch condition search unit, a process of extracting a variable having a high correlation with a variable forming a branch condition before updating is performed.

8. The prediction rule calibration method according to claim 7, wherein in the branch condition search unit and the threshold optimization unit, a section in which the simplified prediction rule is updated is limited to a lower subtree of a branch condition specified by the calibration information.
